(19) United States
(12) Patent Application Publication
(10) Pub. No.: US 2004/0200107 A1
(43) Pub. Date: Oct. 14, 2004

(54) Antenna pennant attachment device

(76) Inventor: Michael Lehman, Del Mar, CA (US)

Correspondence Address: Steven W. Webb, Law Offices of Steven W. Webb, 655 2nd Street, Encinitas, CA, 92024, US

(21) Appl. No.: 10/823,010

(22) Filed: Apr. 13, 2004

Related U.S. Application Data
(60) Provisional application No. 60/462,136, filed on Apr. 14, 2003.

(51) Int. Cl. G09F 3/16

(52) U.S. Cl. 40/666; 40/594

(57) ABSTRACT

An improved method of attaching paper and cloth pennants and flags to automobile antennae, ropes, and the like is presented. The attachment system consists of a three-part strip of adhesive material and a plastic or metal clip that are inexpensive to produce and simple to use.

### RELATED U.S. APPLICATIONS

This application supplements and completes Provisional Application 60/462,136, filed Apr. 14, 2003.

### BACKGROUND OF THE INVENTION

This invention relates to special mechanisms and features for displaying and affixing decorations and flags. It is related to self-adhering decals, and the like, for automobiles, motorcycles, and other vehicles and watercraft, and other masts, posts, ropes or supporting members.

### BRIEF SUMMARY OF THE INVENTION

This invention is designed to provide a low-cost, flexible means to attach a light-weight pennant or flag to an automobile or other vehicle antenna mast or other vehicles and watercraft, or other masts, posts, ropes or supporting members, while preventing the flag decoration from sliding down the mast. It consists of a single rectangular sheet of transparent or translucent plastic with two strips of transfer adhesive along its opposite edges. The transfer adhesive is covered by a removable plastic or paper cover, which when removed, attaches fixedly to a lightweight cloth, paper or plastic pennant or flag.

The central portion of the invention is not covered by the adhesive, and hence can be wrapped around a narrow mast, usually an automobile antenna, allowing for free rotation around the mast. A plastic clip is provided as part of the invention, that snaps over the antenna mast and has a bead of tacky adhesive inside on the back. The tacky adhesive prevents the clip from sliding down the antenna, and when placed below the pennant, prevents the pennant from sliding down the mast as well.

The adhesive on the edges of the invention is aggressive enough to hold a cloth, plastic, or paper flag while the automobile whose antenna the strip/flag assembly is attached to is subject to strong counter winds.

### BRIEF DESCRIPTION OF THE DRAWINGS

The construction and operation of the invention can be readily appreciated from inspection of the drawings that accompany this application.

FIG. 1 is a perspective view of the invention.

FIG. 2 is a perspective view of the clip.

FIG. 3 is a depiction of the invention attached to a mast

### DETAILED DESCRIPTION OF THE INVENTION

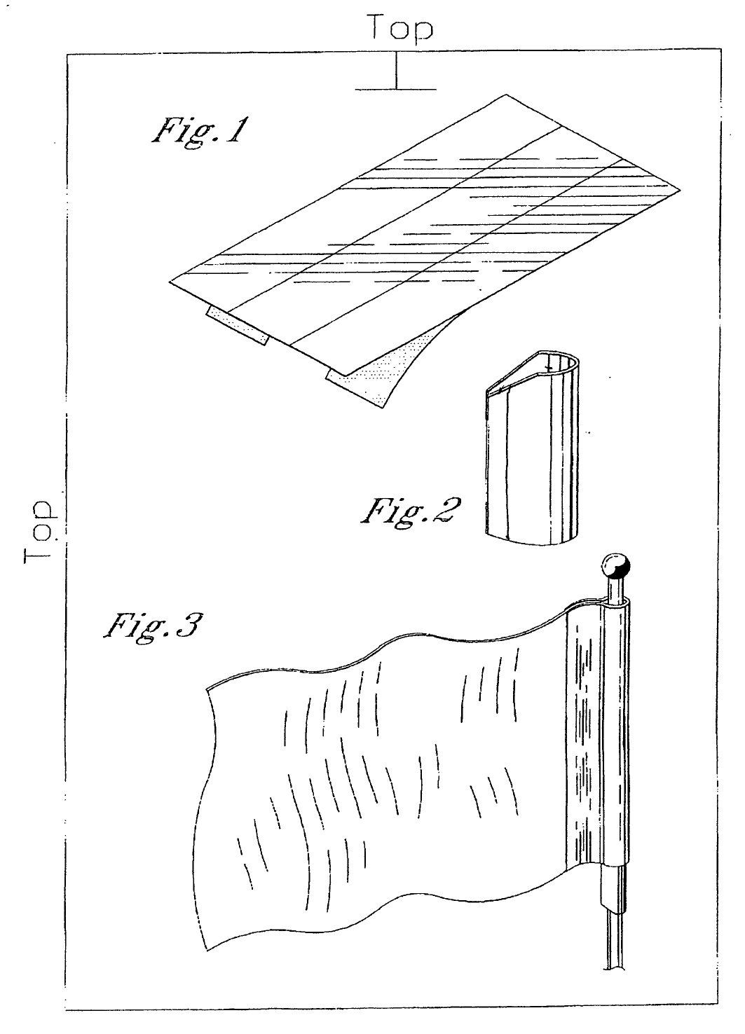

Referring to FIG. 1, the invention¹⁰⁰ in in its flat, unattached form is shown. The adhesive edges^{101,102} are shown with the pealable coverings^{103,104}. The invention¹⁰⁰ can be sized or multiplied to hold a pennant¹⁰⁶ or flag of any reasonable size to a straight antenna mast¹⁰⁷, as shown in FIG. 2. The inside of the central portion¹⁰⁵ is clean of any adhesive when it is placed in contact with the antenna mast¹⁰⁷. The weight of the pennant¹⁰⁶ will be supported by the clip¹¹² when properly attached to the pennant¹⁰⁶ and placed over/around the mast¹⁰⁷.

The invention¹⁰⁰ is used by obtaining the desired pennant⁰⁶ or flag to'be displayed, accompanied by a strip or multiple strips of the invention¹⁰⁰ long enough to accommodate the edge¹⁰⁸ of the pennant¹⁰⁶ to be attached to the mast¹⁰⁷, and then attaching the invention¹⁰⁰ to the pennant¹⁰⁶ and then to the mast¹⁰⁷. The clip¹¹² is attached after the pennant¹⁰⁶ is placed at the desired height on the mast¹⁰⁷.

This is accomplished by removing one strip of the pealable strip¹⁰³, placing the adhesively in contact with one side of the pennant¹⁰⁶ at the edge¹⁰⁸ to be attached to the mast¹⁰⁷ and smoothing the adhesive edge down. The semi-attached invention¹⁰⁰ plus pennant¹⁰⁶ can now be attached to the mast¹⁰⁷ by wrapping the invention central portion¹⁰⁵ around the mast¹⁰⁷, removing the remaining pealable strip¹⁰⁴, and then smoothing the newly uncovered adhesive¹⁰² to the other side of the pennant¹⁰⁶, being careful not to let the adhesive¹⁰² come in contact with the mast 107, so as to allow for free rotation of the pennant around the mast. The clip¹¹² is then slipped over the mast¹⁰⁷ below the pennant¹⁰⁶ by pressing the clip open end¹¹³ over the cylindrical mast¹⁰⁷ until the clip¹¹² snaps into place. The pennant¹⁰⁶ should now stay on the mast¹⁰⁷ yet be able to rotate around the mast¹⁰⁷ as the wind directs.

While the preferred embodiment of the invention has been described, modifications can be made and other embodiments of this invention realized without departing from the intent and scope of any claims associated with this invention.

What is claimed is:

1. A pennant attachment system, comprised of a three-part adhesive strip and a mast clip,
the three-part adhesive strip a flat piece of material in a recangular shape, the flat piece of material possessing a non-adhesive side and an adhesive side,
the non-adhesive side clean of any adhesive material,
the adhesive side possessing three rectangular sections whose long axis parallels the long axis of the three-part adhesive strip,
the two outside rectangular sections covered with a contact adhesive, the two outside rectangular sections also possessing pealable covers that completely cover the contact adhesive,
the central rectangular section clean of any adhesive material,
the mast clip made from a single piece of semi-rigid material, the mast clip shaped in such a fashion that it can be opened and then placed over a slim mast, and held in place on the mast by means of a bead of tacky adhesive inside the mast clip,
the pennant attachment system used by obtaining a pennant to be attached to a mast, obtaining a three-part adhesive strip of sufficient length such that it covers the edge of the pennant to be attached to the mast, pealing off one pealable strip and attaching the corresponding outside rectangular section to the pennant edge by means of the contact adhesive, placing the central rectangular section of the three-part adhesive strip over the mast, then removing the remaining pealable strip and wrapping the three-part adhesive strip around the mast and attaching it to the other side of the edge of the pennant in such a manner that only the central rectangular section is in contact with the mast,
then attaching the mast clip to the mast beneath the pennant in such a manner that the weight of the pennant on the mast is held up by the mast clip and the pennant is prevented from sliding down the mast.

2. A pennant attachment system as in claim 1 where the contact adhesive is strong enough to'hold the weight of a paper pennant.

3. A pennant attachment system as in claim 1 where the contact adhesive is strong enough to hold the weight of a cloth flag.

4. A pennant attachment system as in claim 1 where the mast clip is made of metal.

5. A pennant attachment system as in claim 1 where the mast clip is made of plastic.
